(19) United States
(12) Patent Application Publication
(10) Pub. No.: US 2019/0080607 A1
(43) Pub. Date: Mar. 14, 2019

(54) INTERSECTION MONITORING SYSTEM AND METHOD

(71) Applicant: Continental Automotive Systems, Inc., Auburn Hills, MI (US)

(72) Inventors: Jeremy J. McClain, Ortonville, MI (US); Joseph Zagroba, Auburn Hills, MI (US); Anil Rachakonda, Santa Clara, CA (US)

(21) Appl. No.: 16/189,470

(22) Filed: Nov. 13, 2018

Related U.S. Application Data
(63) Continuation of application No. PCT/US2017/032444, filed on May 12, 2017.
(60) Provisional application No. 62/336,045, filed on May 13, 2016.

(51) Int. Cl. G08G 1/16; G08G 1/01; G08G 1/08; G08G 1/087

(52) U.S. Cl. CPC G08G 1/164; G08G 1/166; G08G 1/087; G08G 1/08; G08G 1/0116

(57) ABSTRACT

An intersection monitoring system includes at least one sensor disposed and configured to detect objects in the proximity of an intersection of roads. A computer processor is in communication with the at least one sensor. The computer processor is configured to determine at least one of a speed, an acceleration, and a heading for each object based on data from the sensors. The computer processor is also configured to estimate the trajectory for each object. The computer processor is further configured to predict a probability for a collision between at least two of the objects based on the estimated trajectory for each object and to send an alert in response to the probability being greater than a predetermined value.

### TECHNICAL FIELD

The technical field relates generally to intelligent transportation systems (“ITS”) and more particularly to traffic sensing to prevent crashes.

### BRIEF SUMMARY

In one exemplary embodiment, a system includes at least one sensor disposed and configured to detect objects in the proximity of an intersection of roads. The system also includes a computer processor in communication with the at least one sensor. The computer processor is configured to determine at least one of a speed, an acceleration, and a heading for each object based on data from the sensors. The computer processor is also configured to estimate the trajectory for each object based on at least one of the speed, acceleration, and heading for each object. The computer processor is further configured to predict a probability for a collision between at least two of the objects based on the estimated trajectory for each object. The computer processor is also configured to send an alert in response to the probability being greater than a predetermined value.

In one exemplary embodiment, a method for alerting a user of a potential collision includes detecting objects in the proximity of an intersection of roads using at least one sensor. The method also includes determining at least one of a speed, an acceleration, and a heading for the objects based on data from the at least one sensor. The method further includes estimating the trajectory for each object based on at least one of the speed, acceleration, and heading for each object. The method also includes predicting a probability for a collision between at least two of the objects based on the estimated trajectory for each object. The method further includes sending an alert in response to the probability being greater than a predetermined value.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a diagram of an intersection monitoring system according to one exemplary embodiment; and

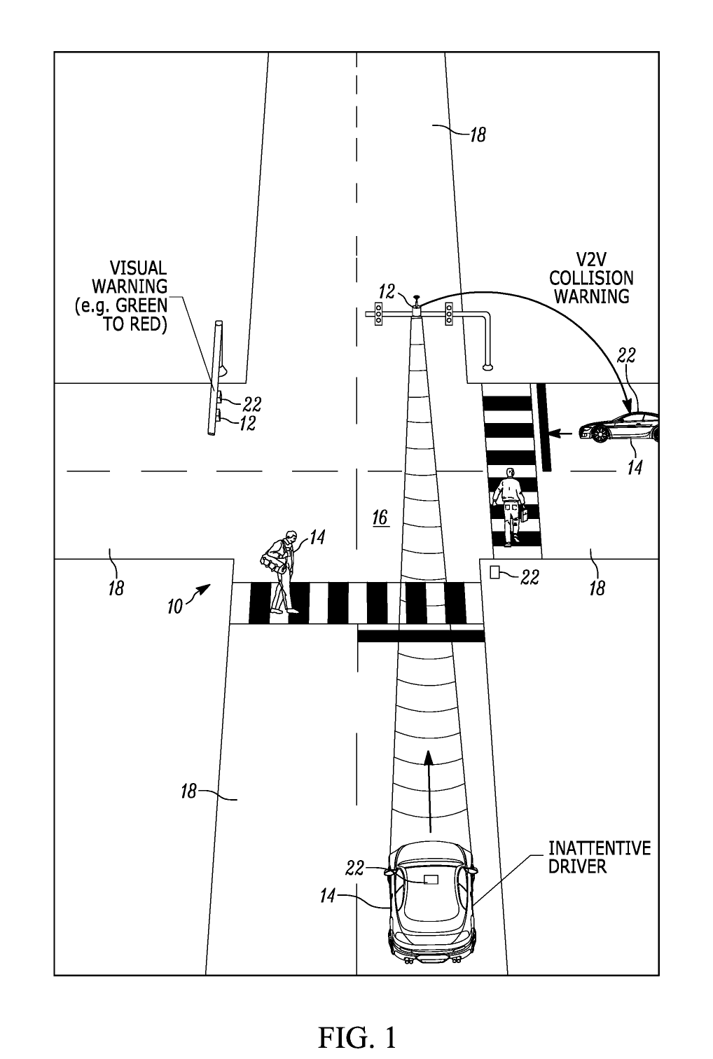

FIG. 2 is a block schematic diagram of the intersection monitoring system according to one exemplary embodiment.

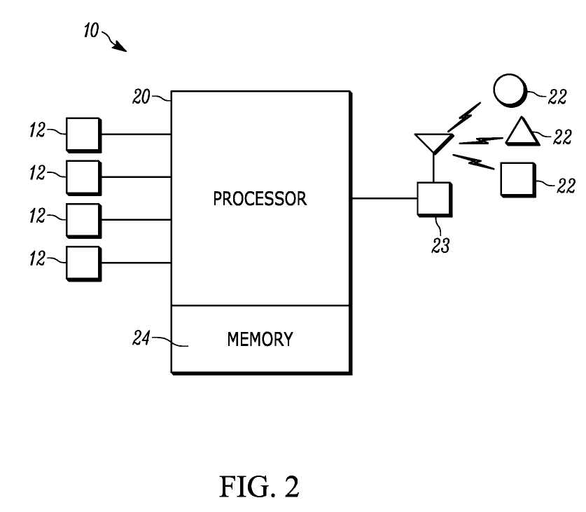

### DETAILED DESCRIPTION

Referring to the Figures, wherein like numerals indicate like parts throughout the several views, an intersection monitoring system 10 and method is shown and described herein.

The system 10 includes at least one sensor 12 for detecting various objects 14. The at least one sensor 12 may be implemented with a single sensor 12 or a plurality of sensors 12. As such, the word sensor 12 and sensors 12 may be used herein without limitation. The objects 14 may be vehicles (e.g., automobiles, trucks, motorcycles, etc.), pedestrians, bicycles, strollers, animals (e.g., dogs). Of course, this list is not exhaustive and other objects 14 may be contemplated.

The sensors 12 of the exemplary embodiments are configured to detect objects 14 in the proximity of an intersection 16 of roads 18. As such, in the exemplary embodiments, the sensors 12 are disposed at or near the intersection 16. For example, each sensor 12 may be disposed on a pole, stanchion, cross-bar, building, or other structure (not shown) at or near the intersection 16. The sensors 12 may be implemented with any of various devices, including, but certainly not limited to, a camera, a radar transceiver, and a lidar transceiver (not separately numbered).

The system 10 also includes a computer processor 20. The computer processor 20 (hereafter referred to simply as the “processor” 20) may include at least one of a microprocessor, microcontroller, an application specific integrated circuits (“ASICs”), a digital signal processor, etc., as is readily appreciated by those skilled in the art. The processor 20 is capable of performing calculations, executing instructions (i.e., running a program), and otherwise manipulating data as is also appreciated by those skilled in the art.

The processor 20 is in communication with the at least one sensor 12. As such, the processor 20 may receive data from the various sensors 12. The processor 20 is configured to determine various characteristics of the objects 14 based on the data provided by the sensors 12. These characteristics include, but are not limited to, type of object 14 (e.g., motorcycle, truck, pedestrian, car, etc.), size of each object 14, position of each object 14, weight of each object 14, travel speed of each object 14, acceleration of each object 14, and heading for each object.

The processor 20 is also configured to estimate the trajectory for each object 14. This estimation is calculated based on at least one of the speed, acceleration, and heading for each object 14. That is, the processor 20 is configured to estimate potential future locations of the object 14 based on current and past location, speed, and/or acceleration.

The processor 20 is further configured to predict a probability for a collision between at least two of the objects 14. This probability is based, at least in part, on the estimated trajectory for each object 14. The probability may be a number corresponding to a likelihood of collision based on various factors including the potential future locations of the objects 14.

The processor 20 may have access to information regarding traffic signals (not shown) at the intersection 16. In one embodiment, the processor 20 may be in communication with a signal controller (not shown) to determine the state of the various traffic signals (e.g., “green light north and southbound, red light east and westbound”, etc.). In another embodiment, the processor 20 may determine the state of the traffic signals based on data provided by the sensors 12. The processor 20 may utilize the information regarding traffic signals in predicting the probability for a collision between objects 14.

The processor 20 may also be configured to send an alert in response to the probability of collision being greater than a predetermined value. That is, if determined that a collision of objects 14 is likely, the processor 20 may issue an alert to one or more users of the system 10 so that corrective action may be taken and the collision be avoided and/or damage reduced.

As such, the system 10 may include one or more annunciators 22 in communication with the processor 20. The annunciator 22 is configured to receive the alert from the processor 20 and providing a corresponding warning to a user of the potential collision. The annunciator 22 may be implemented in one or more of the vehicles, utilizing at least one of a loudspeaker, a light, a display, and an electronic device (e.g., a smart phone). Communication may be achieved, for example, by vehicle-to-vehicle communication (“V2V”) techniques and/or vehicle-to-X (“V2X”) techniques. Of course, other devices and techniques for implementing the annunciator 22 will be apparent to those skilled in the art.

The annunciator 22 may also be implemented outside of a vehicle. For instance, the annunciator may be implemented as part of a traffic signal. For example, in one embodiment, the traffic illuminates a red light in response to the alert. The illumination of the red light may be flashed or otherwise differentiated from normal operation of the traffic signal. As such, drivers without an in-vehicle annunciator 22, bicyclists, and/or pedestrians may learn of the alert, and, accordingly the potential collision.

The system 10 of the exemplary embodiments includes a transmitter 23. The transmitter 23 is in communication with the processor 20 and configured to facilitate the sending of the alert. In one exemplary embodiment, the transmitter 23 is a radio frequency (“RF”) transmitter and/or transceiver often referred to simply as a radio. In another exemplary embodiment, the transmitter 23 is an optical-band transmitter, e.g., an ultraviolet or infrared transmitter. Other transmitters 23 for wireless sending of data will also be appreciated by those skilled in the art.

The system 10 may also include a memory 24 for storing data. The memory 24 is in communication with the processor 20 and/or and the sensors 12 for storing data related to the intersection 16. The memory 24 may be implemented, for example, with semiconductors (e.g., random access memory, read only memory, flash memory, etc.), magnetic media (e.g., floppy disks, hard drives, magnetic tapes, etc.), optical storage (e.g., compact discs, digital versatile discs (DVDs), Blu-ray discs, etc.), and/or any other suitable data storage device.

The data related to the intersection 16 that may be stored in the memory 24 may include, but is certainly not limited to: speeds of vehicles travelling through the intersection, average speeds of vehicles travelling through the intersection, number of vehicles travelling through the intersection, average number of vehicles travelling through the intersection in a time period, types of vehicles travelling though, turning direction of vehicles, and number of vehicles per lane. Other data regarding the intersection 16, e.g., time, date, season, etc., may also be recorded and cross-referenced to the other data.

The data related to the intersection 16 may be used for various purposes. These purposes include, but are not limited to, road planning, connected vehicle efficiency, and navigation route planning. Data could be used for real-time or predictive navigation route planning to avoid unnecessary congestion by avoiding certain lanes and/or routes. Data could also be used to update maps based on lane closures and/or infrastructure changes (e.g., increased number of travel lanes) which can be observed by the infrastructure sensors. Data could also be used by infrastructure to change traffic light timing to increase traffic efficiency in real-time or based on trends/learning.

The processor 20 and/or the memory 24 may be in communication with one or more networks, e.g., the world-wide network commonly known as the Internet. As such, the data regarding the intersection 16 may be made available to various parties for various uses. For example, the data may be made available through one or more application program interfaces (“APIs”). As a result, various applications (e.g., mobile apps running on smartphones) may utilize the data in their operation. In one example, a mobile app could be utilized to condition driving behavior at a particular intersection 16 based on data regarding driving patterns at said intersection 16.

In another example, the data may be utilized by law enforcement to evaluate traffic violations at the intersection 16. In yet another example, the data may be utilized in emergency vehicle driving. Recordings could be stored for law enforcement use after criminal action. Detailed laser data could even help to analyze walking “signatures” etc.

The data, e.g., the number and type of road users detected, may further be used for advertising purposes. For example, if many children are detected (e.g., during school crossing time) advertising (e.g., on a billboard) could change to something more appropriate/targeted toward children. If a baby carriage is detected, then the advertising then targeted toward families. If a sports car is alone at the intersection, then the advertising may be changed to more age-appropriate content.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A system comprising:
at least one sensor disposed and configured to detect objects in the proximity of an intersection of roads; and
a computer processor in communication with said at least one sensor, said computer processor configured to
determine at least one of a speed, an acceleration, and a heading for each object based on data from the sensors;
estimate the trajectory for each object based on at least one of the speed, acceleration, and heading for each object;
predict a probability for a collision between at least two of the objects based on the estimated trajectory for each object; and
send an alert in response to the probability being greater than a predetermined value.

2. The system as set forth in claim 1 further comprising a memory in communication with at least one of said computer processor and said at least one sensor for storing data related to the intersection.

3. The system as set forth in claim 2 wherein the data related to the intersection comprises at least one of speeds of vehicles travelling through the intersection, average speeds of vehicles travelling through the intersection, number of vehicles travelling through the intersection, and average number of vehicles travelling through the intersection in a time period.

4. The system as set forth in claim 1 further comprising a transmitter in communication with said computer processor and configured to facilitate the sending of the alert.

5. The system as set forth in claim 4 wherein said transmitter is further defined as a radio frequency (“RF”) transmitter.

6. The system as set forth in claim 1 wherein said at least one sensor comprises at least one of a camera, a radar transceiver, and a lidar transceiver.

7. The system as set forth in claim 1 further comprising an annunciator in communication with said computer processor for receiving the alert from said processor and providing a warning to a user of the potential collision.

8. The system as set forth in claim 7 wherein said annunciator comprises at least one of a loudspeaker, a light, a display, and an electronic device.

9. The system as set forth in claim 7 wherein said annunciator comprises a traffic signal and wherein said traffic signal illuminates a red light in response to the alert.

10. A method for alerting a user of a potential collision, said method comprising:
detecting objects in the proximity of an intersection of roads using at least one sensor; and
determining at least one of a speed, an acceleration, and a heading for the objects based on data from the at least one sensor;
estimating the trajectory for each object based on at least one of the speed, acceleration, and heading for each object;
predicting a probability for a collision between at least two of the objects based on the estimated trajectory for each object; and
sending an alert in response to the probability being greater than a predetermined value.

11. The method as set forth in claim 10 further comprising storing data related to the intersection in a memory in communication with at least one of the computer processor and the at least one sensor.

12. The method as set forth in claim 11 wherein the data related to the intersection comprises at least one of speeds of vehicles travelling through the intersection, average speeds of vehicles travelling through the intersection, number of vehicles travelling through the intersection, and average number of vehicles travelling through the intersection in a time period.

13. The method as set forth in claim 10 wherein the sending the alert comprises sending the alert with a transmitter in communication with the computer processor.

14. The method as set forth in claim 13 wherein the transmitter is a radio frequency (“RF”) transmitter.

15. The method as set forth in claim 10 wherein the at least one sensor comprises at least one of a camera, a radar transceiver, and a lidar transceiver.

16. The method as set forth in claim 10 further comprising receiving the alert from the processor at an annunciator in communication with the processor and providing a warning to a user of the potential collision.

17. The method as set forth in claim 16 wherein the annunciator comprises at least one of a loudspeaker, a light, a display, and an electronic device.

18. The system as set forth in claim 16 wherein the annunciator comprises a traffic signal and wherein the traffic signal illuminates a red light in response to the alert.
